(19) United States
(12) Patent Application Publication
(10) Pub. No.: US 2023/0231161 A1
(43) Pub. Date: Jul. 20, 2023

(54) FUEL CELL DEVICE WITH INCREASED SERVICE LIFE

(71) Applicant: Robert Bosch GmbH, Stuttgart (DE)

(72) Inventor: Peter Horstmann, Leonberg (DE)

(21) Appl. No.: 17/988,310

(22) Filed: Nov. 16, 2022

(30) Foreign Application Priority Data
Nov. 17, 2021 (DE) 10 2021 212 908.0

(51) Int. Cl. H01M 8/04007; H01M 8/0612

(52) U.S. Cl. CPC H01M 8/04074; H01M 8/0618; H01M 2008/1293

(57) ABSTRACT

A fuel cell device (10) comprising a reformer (26) is disclosed, which is provided for reforming fuel (B) for electrochemical conversion in a fuel cell unit (12), and a fuel cell unit (12), which is provided to electrochemically convert reformed fuel (RB). It is proposed to arrange a heat exchanger (40) downstream of the reformer (26) and upstream of the fuel cell unit (12) in relation to a supply of reformed fuel (RB) to the fuel cell unit (12).

### BACKGROUND OF THE INVENTION

The present invention relates to a fuel cell device comprising a reformer, which is provided for reforming fuel for electrochemical conversion in a fuel cell unit, and a fuel cell unit, which is provided to electrochemically convert reformed fuel.

Fuel cell devices are already known which have a reformer for reforming fuel for electrochemical conversion in a fuel cell unit, wherein the reforming process is supported by radiated heat of a fuel cell unit. In most cases, a large part of the fuel is reformed in the reformer. However, as a rule, not all of the fuel is reformed in the reformer. A relatively small part of the fuel usually remains, which is then reformed in the fuel cell unit. This reforming takes place endothermically, as a result of which the fuel cell unit is cooled. This in turn creates temperature differences in the fuel cell unit, which in the long term can lead to degradations.

### SUMMARY OF THE INVENTION

The present invention is, in contrast, now characterized by a heat exchanger which, in relation to a supply of reformed fuel to the fuel cell unit, is arranged downstream of the reformer and upstream of the fuel cell unit. The previously described temperature differences in the fuel cell unit can thereby be kept low, which in turn reduces degradations. The service life of the fuel cell unit and thus also of the fuel cell device is correspondingly increased.

Due to the features listed in the dependent claims, advantageous embodiments of the invention according to the main claim are possible. It is thus advantageous if the heat exchanger is provided to transfer heat from an exhaust gas, in particular of an afterburner and/or the fuel cell unit, to the reformed fuel. This enables particularly good heat transfer, whereby the above-described temperature differences in the fuel cell unit are kept particularly effectively low and in addition corresponding degradations can be efficiently reduced. Accordingly, the service life of the fuel cell unit and thus also of the fuel cell device can be increased particularly markedly.

It is particularly advantageous if, in relation to a discharge of an exhaust gas from an afterburner, the heat exchanger is arranged downstream of the afterburner. This enables an advantageous realization of the heat transfer described above.

It is also particularly advantageous if, in relation to a discharge of an exhaust gas from an afterburner, the heat exchanger is arranged upstream of the afterburner and/or, in relation to a discharge of an exhaust gas from the fuel cell unit, said heat exchanger is arranged downstream of the fuel cell unit. This also enables an advantageous realization of the heat transfer described above.

### BRIEF DESCRIPTION OF THE DRAWINGS

An exemplary embodiment of the invention is illustrated schematically in the drawings and explained in more detail in the following description. In the drawings:

FIG. 1 shows a schematic circuit diagram of an exemplary embodiment of a fuel cell device.

### DETAILED DESCRIPTION

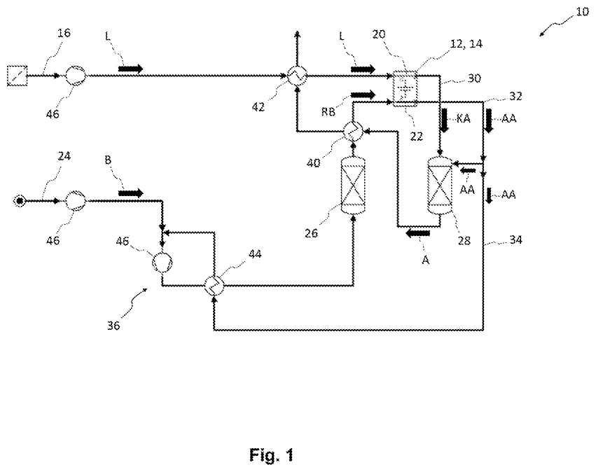

FIG. 1 shows a schematic circuit diagram of an exemplary embodiment of a fuel cell device 10. The fuel cell device 10 comprises a fuel cell unit 12, in the present case a fuel cell stack 14. The fuel cell unit 12 or the fuel cell stack 14 has a plurality of fuel cells, in the present case solid oxide fuel cells (SOFC).

In a normal operation, for example, of the fuel cell device 10, oxygen-containing air L is supplied via an air supply line 16 to a cathode chamber 20 of the fuel cell unit 12, while reformed fuel RB, in the present case hydrogen, is supplied to an anode chamber 22 of the fuel cell unit 12. In the fuel cell unit 12, the reformed fuel RB is electrochemically converted by the interaction of oxygen from the air L while generating electricity and heat.

The reformed fuel RB is generated by supplying fuel B, in the present case natural gas, to the fuel cell device 10 via a fuel supply line 24, which fuel is then reformed in a reformer 26. Such reforming takes place endothermically.

Downstream, the fuel cell unit 12 is connected to an afterburner 28. Exhaust gas of the fuel cell unit 12 is fed to the afterburner 28, in the present case cathode exhaust gas KA via a cathode exhaust gas line 30 and a part of the anode exhaust gas AA via an anode exhaust gas line 32. The cathode exhaust gas KA contains unused air L or unused oxygen, while the anode exhaust gas AA may contain non-converted, reformed fuel RB and/or possibly non-reformed fuel B. By means of the afterburner 28, the anode exhaust gas AA or the non-converted, reformed fuel RB possibly contained therein and/or the non-reformed fuel B possibly contained therein, is burned, with admixture of the cathode exhaust gas KA or of the oxygen of the air L contained therein, whereby additional heat can be generated.

Furthermore, the fuel cell device 10 has a return line 34, by means of which a part of the anode exhaust gas AA can be branched off from the anode exhaust line 32 and fed to an anode recirculation circuit 36.

By means of the anode recirculation circuit 36, the branched-off part of the anode exhaust gas AA can be fed back or re-supplied to the anode chamber 22 of the fuel cell unit 12 and/or to the reformer 26, so that the non-converted, reformed fuel RB possibly contained in the branched-off anode exhaust gas AA can subsequently be converted in the fuel cell unit 12 and/or the non-reformed fuel B possibly contained in the branched-off anode exhaust gas AA can subsequently be reformed in the reformer 26. The efficiency of the fuel cell device 10 can thereby be further increased. In addition, via the fuel feed line 24, fresh fuel B can be admixed into the branched-off anode exhaust gas AA recirculated in the anode recirculation circuit 36.

It may happen that not always all the fuel B is reformed in the reformer 26. A relatively small part of the fuel B can remain, which can then also be reformed in the fuel cell unit 12. Since such reforming takes place endothermically, cooling can occur in the fuel cell unit 21. This in turn creates temperature differences in the fuel cell unit 12, which in the long term can lead to degradations.

The present fuel cell device now has a heat exchanger 40 which, in relation to a supply of reformed fuel RB to the fuel cell unit 12, is arranged downstream of the reformer 26 and upstream of the fuel cell unit 12. The previously described temperature differences in the fuel cell unit 12 can thereby be kept low, which in turn reduces degradations. The service life of the fuel cell unit 12 and thus also of the fuel cell device 10 is correspondingly increased.

The heat exchanger 40 is provided for transferring heat from an exhaust gas A of the afterburner 28 to the reformed fuel RB upstream of the fuel cell unit 12. The heat can thus be guided particularly well to the fuel cell unit 12, whereby in turn the previously described temperature differences in the fuel cell unit are particularly effectively kept low and in addition corresponding degradations can be efficiently reduced.

In the case shown, in relation to the discharge of the exhaust gas A from the afterburner 28, the heat exchanger 40 is arranged downstream of the afterburner 28. The hot exhaust gas A produced during combustion in the afterburner 28 is thus discharged from the afterburner 28 via the heat exchanger 40 by means of an exhaust gas line 34. The heat exchanger 40 is in turn fluidically connected to the reformer 26 so that heat is transferred from the hot exhaust gas A to the reformed fuel RB discharged from the reformer 26. Accordingly, the heat of the hot exhaust gas A can be used for reforming, in the fuel cell unit 12, a fuel B which may not have been reformed in the reformer 26. In the exemplary embodiment shown, the heat exchanger 40 is a first heat exchanger 40.

Furthermore, the fuel cell device 10 has a second heat exchanger 42, by means of which the supplied air L is preheated. Here, the second heat exchanger 42, in relation to the supply of air L in the air supply line 16, is arranged upstream of the fuel cell unit 12 and, in relation to the discharge of the exhaust gas A, is arranged downstream of the first heat exchanger 40. After passing through the first heat exchanger 40, the residual heat remaining in the exhaust gas A is thus transferred to the air L flowing in the air supply line 16.

Furthermore, the fuel cell device has a third heat exchanger 44, which is arranged in the anode recirculation circuit 36. By means of the third heat exchanger 44, for the thermal treatment of freshly supplied fuel B, heat from the branched-off anode exhaust gas AA is transferred from the return line 34 to the fuel mixture formed by the admixture of the fresh fuel B in the anode recirculation circuit 36.

The supply of air L in the air supply line 16, the supply of fuel B in the fuel supply line 24 and the recirculation rate of the anode exhaust gas AA in the anode recirculation circuit 36 can be regulated and/or coordinated with one another via compressors 46 in the respective lines.

In an alternative embodiment, which is not illustrated in more detail, it would also be possible for the heat exchanger 40, in relation to a discharge of the exhaust gas A from the afterburner 28, to be arranged upstream of the afterburner 28 and/or, in relation to a discharge of cathode exhaust gas KA from the fuel cell unit 12, to be arranged downstream of the fuel cell unit 12. The cathode exhaust gas KA could thus be guided from the fuel cell unit 12 via the heat exchanger 40 to the afterburner 28 by means of the cathode exhaust gas line 34. The heat exchanger 40 could in turn be fluidically connected to the reformer 26 so that heat could be transferred from the cathode exhaust gas KA to the reformed fuel RB discharged from the reformer 26. The heat of the cathode exhaust gas KA could correspondingly be used for reforming, in the fuel cell unit 12, a fuel B which may not have been reformed in the reformer 26.

1. A fuel cell device (10) comprising a fuel cell unit (12), and a reformer (26) configured to reform fuel (B) for electrochemical conversion in the fuel cell unit (12), wherein the fuel cell unit (12) is configured to electrochemically convert reformed fuel (RB) from the reformer (26), further comprising a heat exchanger (40) which, in relation to a supply of reformed fuel (RB) to the fuel cell unit (12), is arranged downstream of the reformer (26) and upstream of the fuel cell unit (12).

2. The fuel cell device (10) according to claim 1, characterized in that the heat exchanger (40) is configured to transfer heat from an exhaust gas (KA, A) to the reformed fuel (RB).

3. The fuel cell device (10) according to claim 2, characterized in that, in relation to a discharge of an exhaust gas (A) from an afterburner (28), the heat exchanger (40) is arranged downstream of the afterburner (28).

4. The fuel cell device (10) according to claim 2, characterized in that, in relation to a discharge of an exhaust gas (A) from an afterburner (28), the heat exchanger (40) is arranged upstream of the afterburner (28).

5. The fuel cell device (10) according to claim 4, characterized in that, in relation to a discharge of an exhaust gas (KA) from the fuel cell unit (12), the heat exchanger is arranged downstream of the fuel cell unit (12).

6. The fuel cell device (10) according to claim 2, characterized in that, in relation to a discharge of an exhaust gas (KA) from the fuel cell unit (12), the heat exchanger is arranged downstream of the fuel cell unit (12).

7. The fuel cell device (10) according to claim 1, characterized in that the heat exchanger (40) is configured to transfer heat from an exhaust gas (KA, A) of an afterburner (28) and/or of the fuel cell unit (12) to the reformed fuel (RB).

8. The fuel cell device (10) according to claim 7, characterized in that, in relation to a discharge of an exhaust gas (A) from an afterburner (28), the heat exchanger (40) is arranged downstream of the afterburner (28).

9. The fuel cell device (10) according to claim 7, characterized in that, in relation to a discharge of an exhaust gas (A) from an afterburner (28), the heat exchanger (40) is arranged upstream of the afterburner (28).

10. The fuel cell device (10) according to claim 9, characterized in that, in relation to a discharge of an exhaust gas (KA) from the fuel cell unit (12), the heat exchanger is arranged downstream of the fuel cell unit (12).

11. The fuel cell device (10) according to claim 7, characterized in that, in relation to a discharge of an exhaust gas (KA) from the fuel cell unit (12), the heat exchanger is arranged downstream of the fuel cell unit (12).
